(19) United States
(12) Patent Application Publication
(10) Pub. No.: US 2012/0246334 A1
(43) Pub. Date: Sep. 27, 2012

(54) UNIFIED WEB SERVICE URI BUILDER AND VERIFICATION

(75) Inventors: Li Yang, Kirkland, WA (US); Christian Liensberger, Bellevue, WA (US); Chunjia Li, Bellevue, WA (US)

(73) Assignee: Microsoft Corporation, Redmond, WA (US)

(21) Appl. No.: 13/052,717

(22) Filed: Mar. 21, 2011

(51) Int. Cl. G06F 15/16

(52) U.S. Cl. 709/232

(57) ABSTRACT

Verifying a translation middleware piece. A first request is provided to a front end user service using a protocol appropriate for the front end user service, including a translation middleware piece. The translation middleware piece translates requests provided to the front end service to requests for back-end data stores. A first response to the first request to the front end user service is received. A second request is provided to a back-end data store. The second request to the back-end data store is in a format appropriate for the back-end data store and includes elements that should return the same results as the first request to the front end user service. A second response to the second request to the back-end data store is received. Based on the responses, a functional state is determined for at least one of the, front end, the back-end, or the translation middleware piece.

### BACKGROUND

### Background and Relevant Art

Computers and computing systems have affected nearly every aspect of modern living. Computers are generally involved in work, recreation, healthcare, transportation, entertainment, household management, etc.

Further, computing system functionality can be enhanced by a computing systems ability to be interconnected to other computing systems via network connections. Network connections may include, but are not limited to, connections via wired or wireless Ethernet, cellular connections, or even computer to computer connections through serial, parallel, USB, or other connections. The connections allow a computing system to access services at other computing systems and to quickly and efficiently receive application data from other computing system.

Various computing systems may communicate using disparate communication protocols. Content providers may use a variety of open or proprietary data and messaging formats to receive and respond to data requests from users. For example, content providers might use combinations of the HyperText Markup Language (HTML), the eXtensible Markup Language (XML), the Simple Object Access Protocol (SOAP), the Web Service Definition Language (WSDL), the Atom Syndication Format (ATOM), the JavaScript Object Notation (JSON), Representational State Transfer (REST) etc. Generally, content providers provide custom Application Programming Interfaces (APIs), which allow users to send requests and receive responses.

The flexibility and choice of data and messaging formats available to content providers for implementing custom APIs can complicate user consumption of the data sets and other information the content providers make available through their custom APIs. To request data from a given content provider, users may need to consult that provider's custom API to determine how to send data requests to that content provider, and then determine how to process responses received from that content provider. Further, users may need to perform additional processing on responses to determine whether error conditions exist in connection with the response, and to convert the response into a consumable format. Users may need to repeat this process for each content provider from which the users request data, which can become a time-consuming and complicated task.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

One embodiment disclosed herein is directed to a method practiced in a computing environment. The method includes providing a first request to a front end user service using a protocol appropriate for the front end user service. The front end user service includes a translation middleware piece. The translation middleware piece translates requests provided to the front end service to requests for one or more back-end data stores. A first response to the first request to the front end user service is received. A second request is provided to a back-end data store. The second request to the back-end data store is in a format appropriate for the back-end data store and includes elements that should return the same results as the first request to the front end user service. A second response to the second request to the back-end data store is received. Based on the first and second responses, a functional state is determined for at least one of the, front end, the back-end, or the translation middleware piece.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 illustrates data retrieval using a data wholesaler;

FIG. 2 illustrates testing of a data wholesaler and back-end data storage; and

FIG. 3 illustrates a method of testing a data wholesaler.

### DETAILED DESCRIPTION

Some embodiments described herein may be used with a service that provides a uniform way to expose and access data from disparate sources. This service may be referred to herein as a data wholesaler. The data could be stored in relational tables and exposed by an Open Data Protocol (OData) web service, or exposed by content providers through 3^{rd} party web services such as those based on communication protocols such as SOAP, REST etc. Given the diversity of data sources and data quality, how to efficiently verify whether the data wholesaler web service framework works in the designed way can be challenging.

Some embodiments address these challenges by using a unified web service URL builder and verification technology to simulate the end to end user scenarios by dynamically generating rich queries based on data patterns and data schemas of the data source, and thoroughly validating the results. Some embodiments may be able to provide maximized test coverage with minimized test development cost.

The workflow of the unified web service URL builder and verification technology includes building service request urls based on host environments and web service mapping files (such as CSDL and WSDL etc), sending service requests against web service frameworks and validating the returned service responses. Integrating with the web services technologies and the knowledge of model based tests and the random value generation based on regular expression, the unified web service URL builder and verification technology is able to efficiently and comprehensively cover the web services pipe and is functional for arbitrary web services. Moreover, a stand-alone user interface may be implemented based on the unified web service URL builder and verification technology to allow customizing the service request Urls and returned service response formats, which further provides flexibility and diversity to real world use.

The following now illustrates more detailed embodiments and one suitable operating environment. Some embodiments described herein may include a middleware system that provides information and data brokerage between users and content providers, and that provides uniform APIs to users, enabling users to request data sets and other information from content providers via the middleware system.

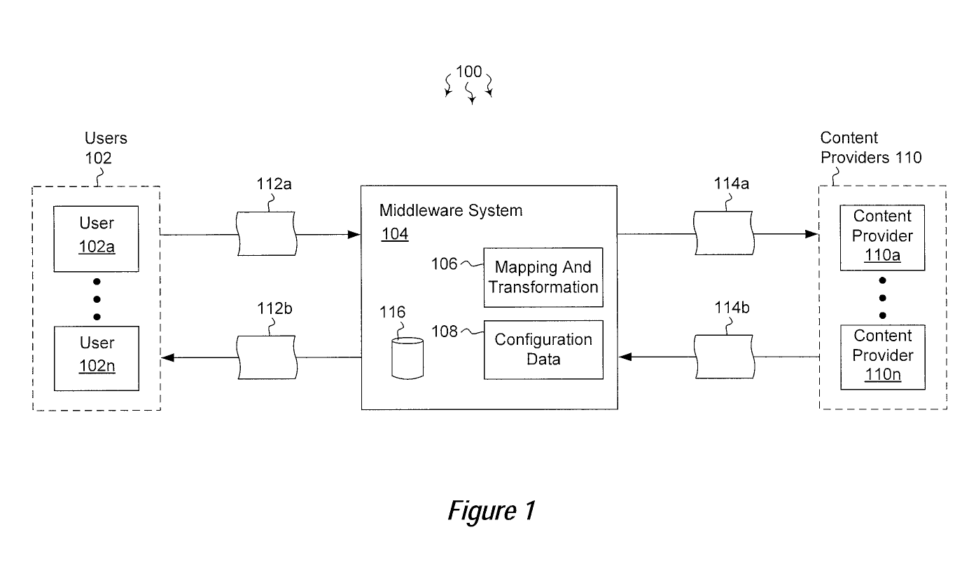

Referring now to FIG. 1 an exemplary information and data brokerage environment 100 is illustrated. FIG. 1 illustrates a middleware system 104 that brokers messages, such as data requests and responses, between users 102 and content providers 110. Middleware system 104 can broker messages between any number of users and any number content providers, as indicated by the vertical ellipses illustrated in connection with users 102 and content providers 110.

Users 102 and middleware system 104 can communicate via any appropriate communications mechanism. In one embodiment, users 102 can be locally connected to middleware system 104, while in other embodiments users 102 can be remotely connected to middleware system 104 via a network connection, such as wired or wireless Ethernet, the Internet, cellular connections, or even computer to computer connections through serial, parallel, USB, or other connections. Similarly, middleware system 104 and content providers 110 can also communicate via any communications mechanism, local or remote, as described above.

Users 102 and middleware system 104 communicate using uniform data and messaging formats. Uniform data and messaging formats, as used herein means a communications protocol that is the same or similar for a given group of entities. In particular, the examples illustrated herein show a uniform protocol for all users 102. For example users 102 and middleware system 104 can communicate with uniform messages 112a and 112b, which may be formatted according to a uniform data and messaging format. In some instances, uniform message 112a might comprise a uniform data request, while uniform message 112b might comprise a uniform response. In some embodiments, middleware system 104 might implement REST-based APIs and use Open Data Protocol (OData)-based messages with a tabular (i.e. rows and columns) data format.

Middleware system 104 and content providers 110 may communicate using custom data and messaging formats. Custom data and messaging formats as used herein means different communications protocols for different entities. For example custom messages 114a and 114b might be formatted according to custom data and messaging formats. For example, some content providers may communicate using a first custom protocol, while other content providers communicate using a second custom protocol. Custom does not necessarily mean proprietary to a particular entity, as a custom protocol may in fact be a standardized protocol. In some instances, custom message 114a may comprise a custom data request, while custom message 114b may comprise a custom response.

Content providers 110 may each implement custom APIs that define corresponding custom data and messaging formats. Absent middleware system 104, these custom APIs can complicate access by users 102 to data sets and other information provided by content providers 110. For example, content provider 110a might implement a custom SOAP-based API with corresponding custom data and messaging formats, while content provider 110n might implement a different custom WSDL-based API with corresponding custom data and messaging formats. Users requesting data directly from either of content provider 110a or 110n may need to learn that content provider's custom API, and then communicate directly with that content provider using the content provider's custom data and messaging formats. Furthermore, users requesting data directly from both of providers 110a and 110n might need to learn custom APIs for both of providers 110a and 110n.

Middleware system 104 provides uniform APIs usable by any number of users 102 to make data requests of any number of content providers 110. The uniform APIs define uniform data and messaging formats that enable users 102 to make uniform data requests to content providers 110 via middleware system 104, and to receive uniform responses. Thus, users 102 can use the uniform APIs of middleware system 104 to request and receive data sets and other information from any content provider for which middleware system 104 provides information and data brokerage.

In response to receiving a uniform data request from a user, middleware system 104 can convert the uniform data request to a custom data request that requests data sets and other information from a specific content provider according to that content provider's custom APIs. Middleware system 104 can then send the custom data request to the specific content provider on behalf of the user. In some circumstances, a single uniform data request might be converted to multiple custom data requests. Continuing the above example, middleware system 104 might receive uniform data request 112a from user 102a requesting data sets and other information from content provider 110a (which, in the illustrated example, implements a custom SOAP-based API). Middleware system 104 can convert uniform data request 112a into custom SOAP-based data request 114a that requests data from content provider 110a and forward custom SOAP-based data request 114a to content provider 110a. Content provider 110a can then reply with custom SOAP-based response 114b.

After receiving a custom response from a content provider, middleware system 104 can convert the custom response to a uniform data format that can be stored by middleware system 104 and/or returned to a user. For example, middleware system can include storage 116 for storing uniform data. Additionally or alternatively, middleware system 104 can send a uniform response to the requesting user containing all or part of the uniform data. In some circumstances, uniform data from multiple custom messages can be included in a single uniform response. Still continuing the above example, middleware system 104 can convert all or part of custom SOAP-based response 114b to a uniform data format. Middleware system 104 can store the uniform data at storage 116. Additionally or alternatively, middleware system 104 can send uniform response 112b to user 102a. Uniform response 112b can include all or part of custom SOAP-based response 114b, converted to uniform data.

Notably, a single custom response may include data sets and other information from multiple sources, such as data from multiple custom responses from a single content provider, or data from multiple content providers. Furthermore it is noted that, while embodiments are described in the context of a request/response framework in which custom response messages are received in response to uniform data requests, the invention is not so limited and can be practiced in any appropriate communication context. For example, the invention can also be practiced within a subscription context such that once a subscription is initially configured a response message 114b can be received by middleware system 104 from a content provider 110 without a user 102 first sending a uniform data request 112a to the content provider 110. Furthermore, the invention can also be practiced in an asynchronous communication context, in which there may not be a direct correlation between requests and responses. Thus, the invention can be practiced in any situation in which users 102 send messages to content providers 110, and/or in which content providers 110 send responses to users 102, regardless of the particular message flow.

In some embodiments, middleware system 104 may include a mapping and transformation component 106 and configuration data 108. Mapping and transformation component 106 can be used by middleware system 104 to transform uniform requests from users 102 to custom requests that can be sent to content providers 110. Mapping and transformation component 106 can also be used by middleware system to map custom responses and data received from content providers 110 to uniform data formats and responses that can be stored and/or sent to users 102.

In some embodiments, the middleware system 104 implements a runtime module that accesses configuration data 108 to provide information and data brokerage. For example, mapping and transformation component 106 can comprise a runtime module configured by configuration data 108. In other embodiments, middleware system 104 can generate code from configuration data 108. For example, mapping and transformation component 106 can comprise generated code that is generated, at least in part, based on configuration data 108. Of course, middleware system 104 can also comprise custom code, or can comprise any combination of a runtime module, generated code, and/or custom code.

Referring to configuration data 108, middleware system 104 can include configuration data for each content provider 110. Configuration data 108 can define, among other things, provider information that is used to transform uniform messages to custom messages for a given content provider, and mapping information that is used to map custom messages from a given provider to uniform data and messaging formats. Configuration data 108 can also include other information, such as parameter definition and validation information, custom namespace information, error checking information, paging information, and the like. Configuration data 108 may be formatted in any suitable format, such as for example an XML format. In one embodiment, configuration data 108 may be formatted in accordance with the Conceptual Schema Definition Language (CSDL).

Provider information defines basic information for communicating with each content provider 110, including information defining how use data from a uniform data request to create a custom data request using a particular content provider's custom API. The provider information can define, among other things, a base Uniform Resource Identifier (URI) that identifies how and/or where to access the particular content provider, and a request body that defines the format and structure of a custom message for that provider. An exemplary base URI definition might define a URI path to the content provider and possibly parameters. Parameters might take the form of name/value pairs comprising statically-defined values, or placeholders for user-supplied values (provided in the user's request). For instance, for a given provider method, configuration data 108 can include a “FunctionImport” XML node that identifies the provider method and includes a reference to the base URI for the method. One non-limiting example might be:

```
<FunctionImport
  Name=”MyWebServiceMethod”
  EntitySet=”MyEntities”
  ReturnType=”Collection(MyServie.MyEntityType)”
  BaseUri=”http://services.organization.net/MyServicePath?name=
  {name}”>
```

Further, when a content provider's custom API permits or requires custom messages to include a message body, the provider information can define the format and structure of the message body. For example, a message body might comprise SOAP-formatted information comprising hierarchically-structured nodes having elements and/or attributes that include statically-defined values and/or placeholders for user-supplied values. One non-limiting example of a message body might be:

```
<RequestBody httpMethod=”POST”>
  <![CDATA[soapenv:Envelope xmlns:soapenv=”...” xmlns:MyService=”
http://services.organization.net/MyServicePath”
    <soapenv:Header />
    <soapenv:Body>
      <MyService:ws_MyWebServiceMethod>
        <myWebServiceMethodRequest>
          <UserId>userid</UserId>
          <Password>password</Password>
          <Name>{name}</Name>
        </ myWebServiceMethodRequest>
      </MyService:ws_MyWebServiceMethod>
    </soapenv:Body>
  </soapenv:Envelope>
]]>
</RequestBody>
```

Uniform data requests can include user-supplied parameters and corresponding values. In one embodiment, a placeholder for a user-supplied value might be denoted in the provider information by curly braces that surround a parameter name. For example, when defining a value for a name/value pair, a placeholder for a value for the parameter “Name” may take the form ‘{name}’ as shown in the foregoing base URI and message body examples.

Parameter definition information can provide users 102 with detailed information about available parameters for a particular content provider. For example, a parameter definition can include: the name of the parameter; a type that specifies the type of the parameter, such as string, Boolean, double, float, binary, etc.; an indication of whether or not the parameter is required; validation information that that specifies valid values of the parameter; a description that provides help information for the parameter; sample values; an enumeration of possible values, and the like. Parameter definition information can be published to users 102 through the uniform API.

In one embodiment, parameter definition information can be defined within a “Parameter” XML node that includes parameter definition information defined by attributes of the XML tag. For example, one “Parameter” XML node might include elements or attributes such as: Name=“username”, Type=“String”, Nullable=“false” (indicating the parameter is not required), Regex=“̂[a-zA-Z]*$” (a regular expression for parameter value validation), Description=“A human-readable description of the parameter” or SampleValues=“George|John|Thomas|James”.

Validation information for a parameter can be used by middleware system 104 to verify that a user-supplied parameter is valid prior to sending a custom message to a content provider. Validation information might comprise regular expressions, ranges of values, enums, and the like. For example, if a uniform data request includes an invalid parameter, middleware system 104 may return an error to the requesting user and cease further processing of the request. A parameter might be invalid if it fails to match a regular expression, if it is outside a range of values, or if it does not appear in an enum.

Mapping information can define how to map custom responses from content providers 110 to uniform data and messaging formats that can be stored in storage 116 and/or sent to users 102. In some embodiments, when content providers 110 respond to custom requests, the custom responses include hierarchically-structured response data (e.g., XML-formatted data such as SOAP or WSDL). When mapping hierarchically-structured response data to uniformly-formatted data, middleware system 104 may map the hierarchically-structured data to tabular data (i.e. rows and columns). Mapping hierarchically-structured response data to tabular data enables tabular functions such as joins, queries, and projections. These tabular functions can be used, among other things, to present a plurality of data sets to users 102 as a unified data set.

In one embodiment, mapping information might define a series of queries for mapping hierarchically-structured data to tabular data. For example, configuration data 108 can provide mapping and transformation component 106 with a series of queries to execute on the hierarchically-structured data, and direct mapping and transformation component 106 how to use the results of those queries to map the hierarchically-structured data to tabular data. To illustrate, mapping information can define first queries that, when executed on the hierarchically-structured data, identify repeating nodes in the hierarchically-structured data. Each repeating node can be mapped to a row in the tabular format. Mapping information can also define second queries that, when executed on the hierarchically-structured data, identify elements and/or attributes in the repeating nodes. Each element and/or attribute can be mapped to a column corresponding to a row in the tabular format. The second queries can include absolute queries and/or relative queries. An absolute query returns data that is valid for all of the repeating nodes, while a relative query returns data that is specific to a given repeating node. In one embodiment, the queries may be defined according to the XML Path Language (XPath) query language.

For instance, middleware system 104 might receive a custom response from content provider 110a, such as custom SOAP-based response 114b. Mapping information for content provider 110a may define a plurality of XPath queries for extracting rows and columns from custom SOAP-based messages from content provider 110a. First XPath queries can determine repeating XML nodes in a custom SOAP-based response 114b, while second XPath queries can determine elements and/or attributes of the repeating XML nodes. Results from the first XPath queries can be used to define and populate tabular rows, while results from the second XPath queries can be used to define and populate tabular columns. The second XPath queries may be relative, executed on each repeating node to return elements and/or attributes for that specific node, or the second XPath queries may be absolute, returning elements and/or attributes that apply to all the repeating XML nodes. Of course, the embodiments are not limited to converting SOAP-based messages to tabular formats.

In one embodiment, XPath queries might be defined within an “EntityType” XML node in configuration data 108. One non-limiting example might include:

```
<EntityType Name=“MyEntityType” ... Map=“/MyResponse/
MyEntities”>
  <Property Name=“Amount” ... Map=“./Remaining[@Amount]” />
  <Property Name=“City” ... Map=“./City” />
  <Property Name=“State” ... Map=“./State” />
  <Property Name=“Zip” ... Map=“./Zip” />
</EntityType>
```

In this example, the XPath query, “/MyResponse/MyEntities” might identify a plurality of repeating “MyEntities” nodes in the response, which are then mapped to tabular rows. Each “Property” XML node can then identify elements or attributes of each repeating “MyEntities” node via secondary XPath queries and map any corresponding values to tabular columns (e.g. Amount, City, State, and Zip columns). In this example, each secondary XPath query is a relative XPath query (relative to a given “MyEntities” repeating node), as denoted by the dot (“.”) operator.

Custom SOAP-based response 114b might, in one embodiment, represent a hierarchically-structured weather forecast for a given day. In this example, the hierarchically-structured data may include a plurality of repeating “forecast” nodes that represent different weather forecasts for each hour of the given day. Furthermore, each repeating “forecast” node might include one or more elements and/or attributes defining a specific weather forecast, such as temperature, precipitation, barometric pressure, etc. Each repeating “forecast” node might also include or be associated with information valid for all repeating “forecast” nodes, such as a forecast date or a copyright statement. To convert the hierarchically-structured weather forecast data to tabular data, the first set of queries may return each of the repeating “forecast” nodes, and map these nodes to tabular rows. Then, the second set of queries may return elements and/or attributes of the repeating “forecast” nodes, and map these elements and/or attributes to tabular columns. When performing the second set of queries, a relative query may be performed relative to each “forecast” node to determine temperature, precipitation, barometric pressure, etc. for that node; whereas an absolute query may be performed to determine a forecast date or copyright information for all the repeating “forecast” nodes.

Configuration data 108 may include other information such as custom namespace identifiers that identify namespaces to be used in XPath queries. In some instances, namespaces of custom messages could be different from the namespace of configuration data 108. Configuration data may define custom namespace identifiers for use within these XPath queries. In one example, a custom namespace might be defined within a “Namespace” XML node in which a “Prefix” element or attribute defines an abbreviation for the namespace, and a “Uri” attribute defines a URI to the namespace definition. In one non-limiting example, a custom namespace identifier might be:

<Namespace Prefix=“p” Uri=“http://schemas.organization.net/Foo”/>

In this example, the prefix “p” can be used in connection with an XPath query to denote that the XPath query is to be performed within the “http://schemas.organization.net/Foo” namespace.

Configuration data 108 may also include error handling information that may be used by middleware system 104 to verify whether custom messages from content providers 110 indicate error conditions. Error handling information can include mappings that map error conditions to error codes and/or error messages. In some embodiments, when an error occurs while content providers 110 are processing custom requests, custom response messages indicate the error condition through a status code for the message itself (e.g., with an HTTP status code). In this situation, middleware system 104 might take some remedial action, such as sending a notification to the requesting user that the error condition has occurred and/or ceasing further processing of the custom message. However, in other embodiments, content providers 110 might provide custom response messages with status codes for the message itself indicating success (e.g. with an HTTP status code), but also includes an indication of the error condition within a body of the custom message. In these situations, middleware system 104 may detect the error condition by parsing the body of the custom message for an indication of the error condition prior to converting the custom message to a uniform data and messaging format. If an error condition is detected, middleware system 104 may use the error handling information to map the detected error condition to a status code (such as an HTTP status code) and/or an error message, and then take some remedial action, such as sending a notification to the requesting user that the error has occurred and/or ceasing further processing of the custom message. In some cases, the middleware system may parse the body of custom messages for error conditions using XPath queries.

Configuration data 108 may also include paging information that maps uniform paging used by middleware system 104 to custom paging used by content providers 110 and vice-versa. Middleware system 104 and content providers 110 might choose from a multitude of paging approaches, such as a page and page-size approach in which data is requested by reference to a specific page number of a specific page size, or a skip and take approach in which a data request asks a content provider to skip X rows of data and requests the next Y rows. For example, in the page and page-size approach, a page size might be fifty rows, and a data request might ask for the second page of data. By contrast in the skip and take approach, a data request might ask a content provider to skip fifty rows of data and return the next fifty rows. Configuration information 108 can include paging information for each content provider 110 and middleware system 104 can use this paging information to translate the paging approach used by the uniform APIs to the paging approach used by that specific provider. In some cases, based on paging requirements and restrictions of particular content providers, users might need to send a plurality of uniform data requests to receive a requested amount of data, or middleware system 104 might return only a subset of the data returned by a content provider.

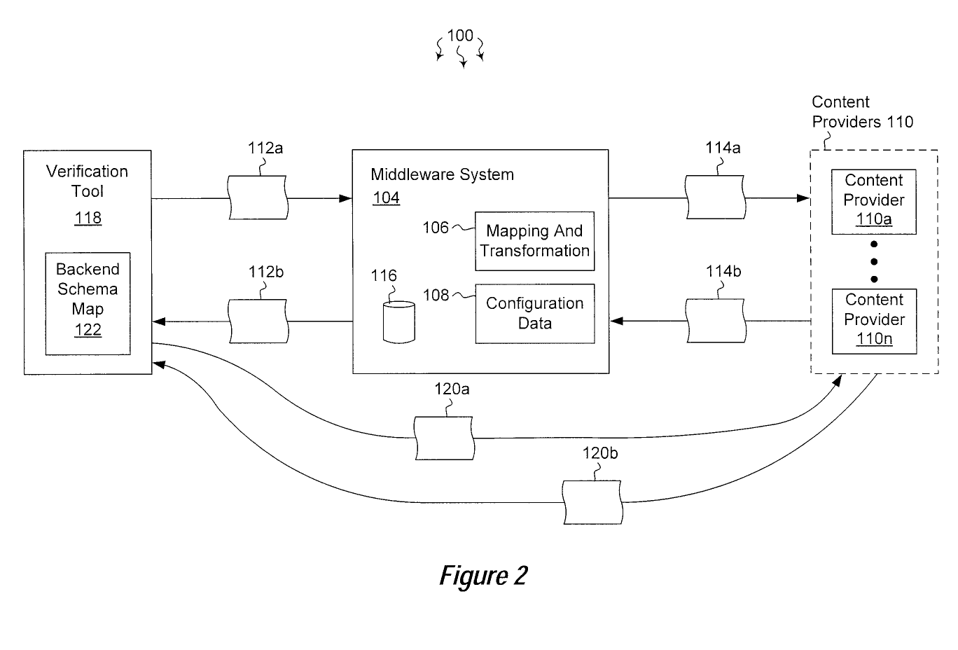

Embodiments may include functionality for validating various portions of a system. For example, FIG. 2 illustrates a verification tool 118. The verification tool 118 includes functionality for verifying the functionality of the middleware system 104 and the content providers 110. FIG. 2 illustrates that custom messages 120a and 120b may be used by the verification tool 118 to communicate directly with content providers 110 without communicating through the middleware system 104. The verification tool 118 can send a custom data request 120a directly to a content provider 110 and receive a custom data response 120b from the content provider 110. Additionally, the verification tool 118 can send a uniform message request 112a through the middleware system 104, which results in the custom request 114a being sent, the custom response 114b being returned, and the uniform response 112b being returned.

Various pieces of the system can then be checked by comparing various messages within the system. For example, the custom request 120a can be compared to the custom request 114a to determine if the middleware system 104 is functioning correctly. Similarly, the custom response 120b can be compared with the custom response 114b and/or the uniform response 112b to determine if the middleware system and the back-end storage including the content providers 110 are functioning correctly. In some embodiments, the verification tool 118 may be able to parse the uniform response 112b to determine what actual data elements were returned and compare that to actual data elements returned by the custom response 120b.

Various checks can be made. For example, some embodiments may check for duplicate data problems. For example, the uniform response 112b may return data items that are duplicates of each other. This can indicate a problem with the middleware system 104 in the mapping and transformation component 106 or some other portion of the middleware system 104. Some embodiments may check for missing mappings. For example, the uniform response 112b may exclude data that is included in one or more corresponding custom responses 120b. This may indicate a missing mapping in the mapping and transformation component 106 of the middleware system. Some embodiments may include functionality for detecting dropped error messages. For example, an error message may be returned in a custom response 120b where a corresponding error is not returned a uniform response 112b.

Some embodiments may be implemented where the verification tool 118 can generate automatic queries for comparison. In particular, automatic uniform requests 112a can be generated and corresponding custom requests 120a can be generated. Resulting responses can then be compared to determine system functionality. It should be noted that there is not necessarily a one to one relationship between uniform requests 112a and custom requests 120a. For example, in some embodiments, a single uniform request 112a may result in multiple custom requests 120a, one for each different content provider 110 needed to appropriately service the uniform request 112a. The uniform request 112a may result in the middleware system 104 issuing different custom requests 114a to different content providers 110.

Automatic request generation can be performed so as to attempt to cover significant numbers of use cases. For example, request can be automatically generated to cover all use cases, most use cases, and/or a significant portion of the most common use cases. Various algorithms can be used, which may be limited by various boundaries when covering use cases. Such boundaries may be based on acceptable ranges allowed by database schemas, enums having a constrained set, enumerated types, etc.

The verification tool 118 includes a back-end schema map 122. The back-end schema map 122 contains information about how queries should be executed against the content providers 110 and an indication of what information should be returned given those queries. Additionally, the verification tool 118 may include functionality for updating the schema map 122. In particular, the verification tool 118 can query content providers 110 and compare results from the queries to the back-end schema map 122. If more data items show up than are expected, the back-end schema map 122 can be updated to account for these additional data items. If less data shows up than expected, the back-end schema map 122 can be updated to remove expected data items. The back-end schema map 122 can be used to formulate the custom data requests 120a and the uniform data requests 112a.

Illustrating now some additional details, various features of some embodiments will be illustrated. Embodiments may include functionality for automatically collecting all available offers in the host environment and identifying the web service type for each offer. For example, embodiments may be able to determine the types of protocols needed to communicate with the various content providers 110. For example, such protocols may include one or more of OData, SOAP, REST etc. Embodiments may include functionality for building a data wholesaler service root url based on the host environment. Resource paths can be built based on the root url and function imports defined in the back-end schema map 122 file. Embodiments may build the service query options based on the service provider types.

Embodiments may include functionality to build the content provider service request urls or database queries (such as the custom requests 120a) in parallel with data wholesaler service request (such as the uniform requests 112). As noted above, this can be used to validate the content provider data quality and data availability.

Embodiments may include functionality to implement a model based testing approach to generate a comprehensive collection of system options, filter operators and filter functions to achieve efficient and comprehensive coverage of possible requests that may be handled by a data wholesaler.

For example, some embodiments may include functionality for automatically selecting service parameters in service request urls for web services in the content providers based on whether they are query-able, return-able, required or optional. Some embodiments may include functionality for building the service request urls with sample service parameter values described in the back-end schema mapping files or with random values. Some embodiments may include functionality for generating service parameter values based on supported data types (e.g., int, single, double, decimal, datetime, guid, string, xml, byte, etc) or enum type. Some embodiments may be configured to generate valid numerical values within a data range defined in back-end schema mapping files. Some embodiments may be configured to generate boundary and negative values based on data types and data content patterns.

Embodiments may include a user interface that allows a user to customize service request urls and select service response formats.

As noted above, embodiments may include functionality for validating system components. For example, some embodiments incrementally validate a service response, such as custom response 120b by first checking the HTTP status, then validating the service response doing a row by row comparison, such as a comparison against the uniform response 112b.

Embodiments may validate xpaths in back-end schema mapping file to check for data item duplications, successful mapping of nodes, and correct node names. Embodiments may match the service response schema with the entity name and entity type defined in the back-end schema map 122 to identify possible mapping errors or mis-matching. As noted, embodiments may include functionality for updating a back-end schema map 122 with appropriate xpaths, data items, nodes, mapping and names when validation indicates that such would be appropriate.

Embodiments may verify error mapping by checking error messages reported in xml nodes and HTTP status code in custom responses 120b against those reported in uniform responses 112b.

Some embodiments use a model based test method implementing a web service URL builder and verification technology. Embodiments can build uniform data requests 112a (such as OData service request Urls) and associated custom data requests 120a (such as database queries run against content providers 110) for validating a data wholesaler, such as the middleware system 104.

Embodiments may build a service root url for the middleware system 104 based on a host environment and resource path based. This root url can be stored by the verification tool 118.

Embodiments may feed an input file based on data types to a combinational parameter generator included in the verification tool 118. The input file may be a file that includes various operators that are expected for a system. For example, such operators may include decimal operators, datetime operators, integer operators, string operators, etc. In some embodiments, the input file may simply be a text file enumerating operators by type. The combinational parameter generator automatically generates multiple combinations of filter operators and filter functions from the input file.

In some embodiments the combinational parameter generator may further combine the filter combinational expressions with other system options. For example, database systems in the content providers may include parameters options for operations with database rose such as counting, formatting, selecting, ordering, skipping, etc. These parameter options can be combined with the combination expressions generated using the input file.

The verification tool 118 can create a query for the middleware system 104 and in parallel create an associated/corresponding query that goes against one or more databases and/or services in the content providers 110. Various values can be used to construct the queries. For example, some embodiments may use sampled values to populate queries against the middleware system 104 and the content providers 110. Alternatively or additionally, embodiments may use random value to populate queries against the middleware system 104 and the content providers 110. Alternatively or additionally, embodiments may use a series of pre-defined values to build the queries against the middleware system 104 and the content providers 110.

Some services in the content providers 110 have restrictions on input parameters. The framework can automatically provide values that fall into these restriction. Restrictions are applied to parameter by using, for example, enumerations of values, regex constraints and range constraints.

As noted above, the verification tool 118 may include one or more verification modules configured to compare the middleware system 104 responses (such as uniform response 112b) with the data retrieved from the content providers 110 (such as in custom responses 120b). In some embodiment, comparison may be done on a row by row basis so to be able to match corresponding data irrespective of the format in which the data is received. Embodiments may use a variety of techniques to fetch the corresponding nodes from the data that is returned by a content provider 110. For example, the verification tool 118 may include functionality for performing XPath queries on returned data where the XPath queries facilitate coordinating data from the middleware system 104 with data from content providers 110.

The verification tool 118 may include one or more verification modules configured to identify duplication. For example, a verification module can determine if a mapping in the middleware system 104 returns the same back-end entity twice in the middleware system 104. In particular, a comparison of the uniform response 112b to the custom response, on a row by row basis, can be used to determine duplicative returning of data items.

The verification tool 118 may include one or more verification modules configured to automatically determine whether an error has been produced by middleware system 104 or content providers 110. This is achieved by comparing the response of the content providers 110 with the response of the middleware system 104. In particular, checks can be made to determine if error messages returned by the content providers 110 are passed on by the middleware system 104.

The verification tool 118 may include one or more verification modules configured to perform checks on HTTP status code levels. If the content providers 110 return HTTP error codes, in either the custom response 120b or the uniform response 112b the verification tool can detect that as a content provider 110 issue.

Embodiments may include functionality for further verification if the content providers 110 return an HTTP OK statuses. In particular, the verification tool 118 may include one or more verification modules that apply the error mapping stored in the backend schema map 122 to identify whether the middleware system 104 does valid error mapping or has defects. The verification tool 118 may include one or more verification modules configured to automatically check whether the error codes are being mapped to an appropriate descriptive error in the middleware system 104. In particular, errors received through custom responses 120b can be compared to errors (or the lack thereof) received through uniform responses 112b.

The following discussion now refers to a number of methods and method acts that may be performed. Although the method acts may be discussed in a certain order or illustrated in a flow chart as occurring in a particular order, no particular ordering is required unless specifically stated, or required because an act is dependent on another act being completed prior to the act being performed.

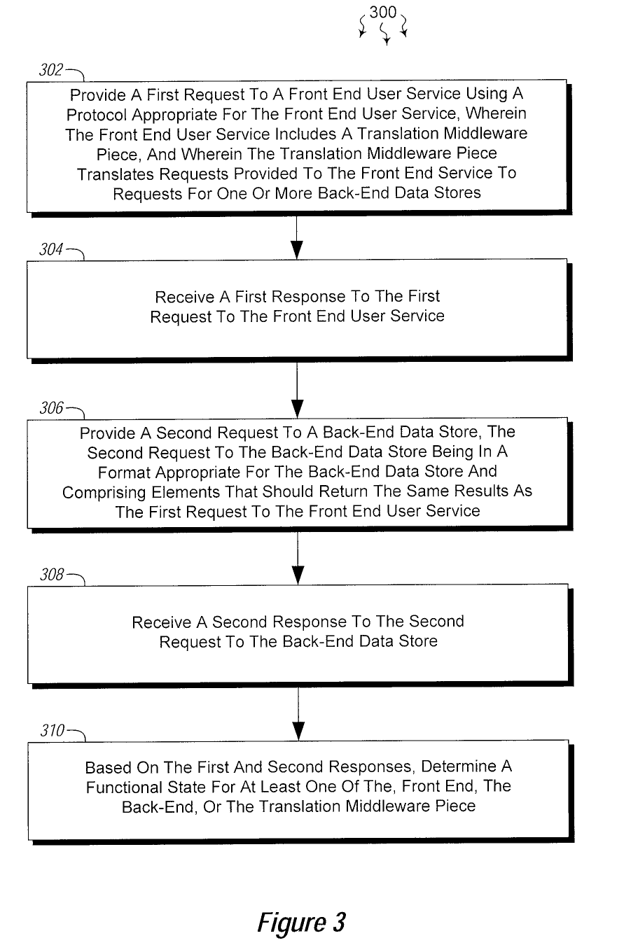

Referring now to FIG. 3, a method 300 is illustrated. The method 300 may be practiced in a computing environment and includes acts for testing and/or improving a translation middleware piece. The method 300 includes providing a first request to a front end user service using a protocol appropriate for the front end user service (act 302). The front end user service includes a translation middleware piece. The translation middleware piece translates requests provided to the front end service to requests for one or more back-end data stores. For example, as illustrated in FIG. 2, the front end may include the middleware system 104. The middleware system 104, as described above, has the capability to receive uniform requests 112a and to translate them into custom requests 114a. The content providers 110 illustrates an example of a back-end data store.

The method 300 further includes receiving a first response to the first request to the front end user service (act 304). For example, the middleware system 104, as noted above, may receive the custom response 114a.

The method 300 further includes providing a second request to a back-end data store (act 306). The second request to the back-end data store is in a format appropriate for the back-end data store. The second request includes elements that should return the same results as the first request to the front end user service. Illustratively, the custom request 120a illustrates an example of the second request. Returning the same results includes returning the same data items. While the responses may be in different formats, the data items therein may be the same.

The method 300 further includes receiving a second response to the second request to the back-end data store (act 308). Custom response 120b illustrates an example of the second response.

The method 300 further includes based on the first and second responses, determining a functional state for at least one of the, front end, the back-end, or the translation middleware piece (act 310). For example, embodiments may be able to determine if portions of the system, including, in the example illustrated, the middleware system 104 or the content providers 110 are functioning correctly or mal-functioning.

The method 300 may further include comparing the first and second responses. Based on the comparison, the method 300 may further include either determining that the translation middleware piece is functioning correctly, or determining the translation middleware piece is mal-functioning.

The method 300 may further include determining that one or more of the responses includes an error and as such determining that at least one of the, front end, the back-end, or the translation middleware piece is malfunctioning. For example, based on errors reported back in the uniform response 112b and/or the custom response 120b, system malfunctions may be detected. For example if the custom response 120b includes an error, but the uniform response 112a does not, then it can be determined that the middleware system 104 is not correctly translating errors.

Malfunctions can be detected in various ways. For example, the method 300 may be practiced where a malfunction of the translation middleware piece is determined based on an error from a data store. Alternatively or additionally, the method 300 may be practiced where a malfunction of the translation middleware piece is determined based on one or more communication issues. Communication issues may result in errors, which can be detected by the system as described above. The method 300 may be practiced where a malfunction of the translation middleware piece is determined based on duplication of data items. As noted, comparisons of responses may reveal duplicates of data items being returned by the middleware system 104, and thus problems with the mapping functionality of the middleware system 104 can be discovered. The method 300 may be practiced where a malfunction of the translation middleware piece is determined based on missing data items. Comparisons of messages, such as the responses 112b and 120b can reveal that data items are missing. This can be used to detect problems with the translation functionality of the middleware system 104.

When malfunctions are detected, various actions can be taken. For example, the method 300 may further include based on the first and second responses updating the translation middleware piece to fix a malfunction. Alternatively or additionally, the method 300 may further include based on the first and second responses, providing to a data store an indication of a problem with the data store. For example, when a malfunction is detected, a determination can be made that the problem lies with one of the content providers 110. An administrator for the content provider 110 can be notified who can then correct the problem.

The method 300 may be practiced where the first and second requests are generated as part of an automatic request generation process to achieve high coverage of request alternatives. Additionally, the first and second requests may be generated a part of a process that attempts to minimize the number of requests while attempting to maximizing coverage of alternatives. In some embodiments, the first and second requests are generated in a limited fashion based on limitations defined in at least one of a range, an enums, a database schema, or a set of enumerated types.

Further, the methods may be practiced by a computer system including one or more processors and computer readable media such as computer memory. In particular, the computer memory may store computer executable instructions that when executed by one or more processors cause various functions to be performed, such as the acts recited in the embodiments.

Embodiments of the present invention may comprise or utilize a special purpose or general-purpose computer including computer hardware, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: physical computer readable storage media and transmission computer readable media.

Physical computer readable storage media includes RAM, ROM, EEPROM, CD-ROM or other optical disk storage (such as CDs, DVDs, etc), magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry or desired program code means in the form of computer-executable instructions or data structures and which can be accessed by a general purpose or special purpose computer. Combinations of the above are also included within the scope of computer-readable media.

Further, upon reaching various computer system components, program code means in the form of computer-executable instructions or data structures can be transferred automatically from transmission computer readable media to physical computer readable storage media (or vice versa). For example, computer-executable instructions or data structures received over a network or data link can be buffered in RAM within a network interface module (e.g., a “NIC”), and then eventually transferred to computer system RAM and/or to less volatile computer readable physical storage media at a computer system. Thus, computer readable physical storage media can be included in computer system components that also (or even primarily) utilize transmission media.

Computer-executable instructions comprise, for example, instructions and data which cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

The present invention may be embodied in other specific forms without departing from its spirit or characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. In a computing environment, a method of improving a translation middleware piece, the method comprising:
providing a first request to a front end user service using a protocol appropriate for the front end user service, wherein the front end user service includes a translation middleware piece, and wherein the translation middleware piece translates requests provided to the front end service to requests for one or more back-end data stores;
receiving a first response to the first request to the front end user service;
providing a second request to a back-end data store, the second request to the back-end data store being in a format appropriate for the back-end data store and comprising elements that should return the same results as the first request to the front end user service; and
receiving a second response to the second request to the back-end data store;
based on the first and second responses, determining a functional state for at least one of the, front end, the back-end, or the translation middleware piece.

2. The method of claim 1, further comprising:
comparing the first and second responses; and
based on the comparison performing one of either determining that the translation middleware piece is functioning correctly, or determining the translation middleware piece is mal-functioning.

3. The method of claim 1, further comprising determining that one or more of the responses comprises an error and as such determining that at least one of the, front end, the back-end, or the translation middleware piece is malfunctioning.

4. The method of claim 1, further comprising based on the first and second responses updating the translation middleware piece to fix a malfunction.

5. The method of claim 1, further comprising based on the first and second responses, providing to a data store an indication of a problem with the data store.

6. The method of claim 1, wherein the first and second requests are generated as part of an automatic request generation process to achieve high coverage of request alternatives.

7. The method of claim 6, wherein the first and second requests are generated a part of a process that attempts to minimize the number of requests while attempting to maximizing coverage of alternatives.

8. The method of claim 7, wherein the requests first and second requests are generated in a limited fashion based on limitations defined in at least one of a range, an enums, a database schema, or a set of enumerated types.

9. The method of claim 1, wherein a malfunction of the translation middleware piece is determined based on an error from a data store.

10. The method of claim 1, wherein a malfunction of the translation middleware piece is determined based on one or more communication issues.

11. The method of claim 1, wherein a malfunction of the translation middleware piece is determined based on duplication of data items.

12. The method of claim 1, wherein a malfunction of the translation middleware piece is determined based on missing data items.

13. A physical computer readable storage medium comprising computer executable instructions that when executed by one or more processors, causes the following to be performed:
sending a first request to a front end user service using a protocol appropriate for the front end user service, wherein the front end user service includes a translation middleware piece, and wherein the translation middleware piece translates requests provided to the front end service to requests for one or more back-end data stores;
receiving a first response to the first request to the front end user service;
sending a second request to a back-end data store, the second request to the back-end data store being in a format appropriate for the back-end data store and comprising elements that should return the same results as the first request to the front end user service;
receiving a second response to the second request to the back-end data store; and
based on the first and second responses, determining a functional state for at least one of the, front end, the back-end, or the translation middleware piece.

14. The computer readable medium of claim 13, further comprising:
comparing the first and second responses; and
based on the comparison performing one of either determining that the translation middleware piece is functioning correctly, or determining the translation middleware piece is mal-functioning.

15. The computer readable medium of claim 13, further comprising determining that one or more of the responses comprises an error and as such determining that at least one of the, front end, the back-end, or the translation middleware piece is malfunctioning.

16. The computer readable medium of claim 13, further comprising based on the first and second responses updating the translation middleware piece to fix a malfunction.

17. The computer readable medium of claim 13, further comprising based on the first and second responses, providing to a data store an indication of a problem with the data store.

18. The computer readable medium of claim 13, wherein the first and second requests are generated as part of an automatic request generation process to achieve high coverage of request alternatives.

19. The computer readable medium of claim 13, wherein a malfunction of the translation middleware piece is determined based on an error from a data store.

20. A computing system comprising:
a middleware translation system, wherein the middleware translation system is configured to translate uniform requests to custom requests for a plurality of backend data stores, the backend data stores comprising one or more of databases or web services, wherein at least two or more of the data stores communicate using different protocols; and
a verification tool coupled to the middleware translation system, wherein the verification tool is configured to:
send a first request to the translation middleware piece which translates the first request to one or more requests to one or more back-end data stores;
receive a first response to the first request from the middleware translation piece;
send one or more second requests to the one or more back-end data stores, the one or more second requests to the one or more back-end data stores being in one or more formats appropriate for the back-end data store and comprising elements that should return the same results as the first request to the middleware translation piece;
receive one or more second responses to the one or more second requests to the one or more back-end data stores; and
based on a comparison of the first and second responses on a row by row basis, determine that the middleware translation piece is malfunctioning.
